(19) United States
(12) Patent Application Publication
(10) Pub. No.: US 2025/0180129 A1
(43) Pub. Date: Jun. 5, 2025

(54) COMBINED VALVE CORE WITH CHANGEABLE FUNCTION AND WATER OUTLET DEVICE

(71) Applicant: RUNNER (XIAMEN) CORP., Xiamen (CN)

(72) Inventor: Qingping WANG, Xiamen (CN)

(73) Assignee: RUNNER (XIAMEN) CORP., Xiamen (CN)

(21) Appl. No.: 18/963,579

(22) Filed: Nov. 28, 2024

(30) Foreign Application Priority Data
Dec. 1, 2023 (CN) 202323286022.2

(51) Int. Cl. F16K 11/074; F16K 39/04

(52) U.S. Cl. CPC F16K 11/0743; F16K 39/045

(57) ABSTRACT

A combined valve core with a changeable function includes a valve core body, where the valve core body includes an outer housing, a base, a first operating portion and a second operating portion; a first water inlet for receiving hot water, a second water inlet for receiving cold water, and a water outlet are arranged on the base; a water flow channel communicating with the first water inlet, the second water inlet and the water outlet is formed in the valve core body; the first operating portion is configured to switch the water flow channel in a first switching manner; and the second operating portion is configured to adjust, in a second switching manner, a flow rate of the hot water and a flow rate of the cold water converged into the water flow channel to adjust a temperature of a water flow leaving from the water outlet.

### CROSS REFERENCE TO THE RELATED APPLICATIONS

This application is based upon and claims priority to Chinese Patent Application No. 202323286022.2, filed on Dec. 1, 2023, the entire contents of which are incorporated herein by reference.

### TECHNICAL FIELD

The present disclosure relates to the technical field of valve cores, and in particular to a combined valve core with a changeable function and a water outlet device.

### BACKGROUND

As a common water outlet device in the field of sanitary wares, shower faucets are provided therein with various valve cores and various buttons. Conventionally, the internal water channel is controlled by a plurality of valve cores, which causes a high design cost. For the existing all-in-one valve core switch, the switching and the temperature adjustment are integrated to the same handle, and the angle of the handle changes easily during switching. Consequently, the temperature is to be readjusted. This is troublesome and causes a poor shower experience.

Based on research in the prior arts, the present disclosure is provided by the applicant.

### SUMMARY

The present disclosure provides a combined valve core with a changeable function and a water outlet device, to solve at least one of the above technical problems.

In order to solve the above technical problems, the present disclosure provides a combined valve core with a changeable function, including a valve core body, where the valve core body includes an outer housing and a base; the base is detachably provided at a bottom of the outer housing; a first water inlet for receiving hot water, a second water inlet for receiving cold water, and a water outlet are arranged on the base; a water flow channel communicating with the first water inlet, the second water inlet and the water outlet is formed in the valve core body; the valve core body further includes a first operating portion and a second operating portion; the first operating portion is configured to switch the water flow channel in a first switching manner; and the second operating portion is configured to adjust, in a second switching manner, a flow rate of the hot water and a flow rate of the cold water converged into the water flow channel to adjust a temperature of a water flow leaving from the water outlet.

As a further improvement, the first operating portion and the second operating portion are coaxial.

As a further improvement, the first switching manner is pressing; and the second switching manner is rotating.

As a further improvement, an output end of the first operating portion is located in the outer housing and configured to switch the water flow channel, and an input end of the first operating portion extends out of the outer housing; and an output end of the second operating portion is located in the outer housing and configured to adjust the temperature of the water flow, and an input end of the second operating portion extends out of the outer housing.

As a further improvement, the combined valve core with a changeable function further includes a pressure balancing module; a connecting cavity communicating with the first water inlet and the second water inlet is further provided in the base; and the pressure balancing module is provided in the connecting cavity.

As a further improvement, the pressure balancing module includes a balancing core and two symmetrical mounting valve seats; a balancing cavity is provided in the mounting valve seat; the two balancing cavities are correspondingly connected; the balancing core is provided between the two balancing cavities, to separate the two balancing cavities apart; one balancing cavity is configured for the hot water to pass through; and the other balancing cavity is configured for the cold water to pass through.

As a further improvement, two ends of the balancing core are open; the middle of the balancing core is provided with a diaphragm, and a circumference of the balancing core is symmetrically provided with two through hole portions; and the through hole portions are respectively provided at two sides of the diaphragm.

The present disclosure further provides a water outlet device, including the combined valve core with a changeable function.

With the above technical solutions, the present disclosure achieves the following technical effects:

According to the combined valve core with a changeable function and the water outlet device provided by the present disclosure, the combined valve core with a changeable function includes a valve core body. The valve core body includes an outer housing and a base. The base is detachably provided at a bottom of the outer housing. A first water inlet for receiving hot water, a second water inlet for receiving cold water, and a water outlet are arranged on the base. A water flow channel communicating with the first water inlet, the second water inlet and the water outlet is formed in the valve core body. The valve core body further includes a first operating portion and a second operating portion. The first operating portion is configured to switch the water flow channel in a first switching manner. The second operating portion is configured to adjust, in a second switching manner, a flow rate of the hot water and a flow rate of the cold water converged into the water flow channel to adjust a temperature of a water flow leaving from the water outlet. By providing the switching and the temperature adjustment on different operating portions, and employing different operating manners, the present disclosure prevents the mutual effect, does not affect the water temperature when the water channel is switched on or off, thereby improving the use experience of the user.

### BRIEF DESCRIPTION OF THE DRAWINGS

To describe the technical solutions in the implementations of the present disclosure more clearly, the accompanying drawings required for describing the implementations are briefly described below. It should be understood that the following accompanying drawings show merely some embodiments of the present disclosure, and thus should not be regarded as a limitation to the scope. A person of ordinary skill in the art may still derive other related accompanying drawings from these accompanying drawings without creative efforts.

FIG. 1 is a schematic exploded view of a combined valve core with a changeable function according to Embodiment 1 of the present disclosure;

FIG. 2 is a schematic sectional view in a switched-on state according to Embodiment 1 of the present disclosure;

FIG. 3 is a schematic sectional view in a switched-off state according to Embodiment 1 of the present disclosure;

FIG. 4 is a schematic structural view of a second operating portion according to the present disclosure;

FIG. 5 is a schematic structural view of a combined valve core with a changeable function according to Embodiment 1 of the present disclosure;

FIG. 6 is a schematic exploded view of a pressure balancing module according to Embodiment 2 of the present disclosure;

FIG. 7 is a partially sectional view according to Embodiment 2 of the present disclosure; and

FIG. 8 is a schematic structural view according to Embodiment 2 of the present disclosure.

In the figures: 1: valve core body, 2: outer housing, 3: base, 4: first operating portion, 5: second operating portion, 6: first water inlet, 7: second water inlet, 8: water outlet, 9: water flow channel, 10: upper rotating shaft housing, 11: lower housing seat, 12: movable ceramic plate, 13: fixed ceramic plate, 14: first water outlet channel, 15: second water outlet channel, 16: third water outlet channel, 17: first water inlet channel, 18: second water inlet channel, 19: converging channel, 20: pressing assembly, 21: sealing shaft, 22: reset spring, 23: upper water distribution housing, 24: inner cavity, 25: through groove, 26: water distributor, 27: pressure balancing module, 28: balancing core, 29: mounting valve seat, 30: balancing cavity, 31: through hole portion, 32: diaphragm, and 33: connecting cavity.

### DETAILED DESCRIPTION OF THE EMBODIMENTS

In order to make the objectives, technical solutions, and advantages in the implementations of the present disclosure clearer, the technical solutions in the implementations of the present disclosure are clearly and completely described below with reference to the drawings in the implementations of the present disclosure. Apparently, the described implementations are merely a part, rather than all of the implementations of the present disclosure. All other implementations derived from the implementations of the present disclosure by those of ordinary skill in the art without creative efforts shall fall within the protection scope of the present disclosure. Therefore, the above detailed description of the implementations of the present disclosure in the accompanying drawings is not intended to limit the protection scope of the present disclosure, but merely indicates selected implementations of the present disclosure. All other implementations derived from the implementations of the present disclosure by those of ordinary skill in the art without creative efforts shall fall within the protection scope of the present disclosure.

### Embodiment 1

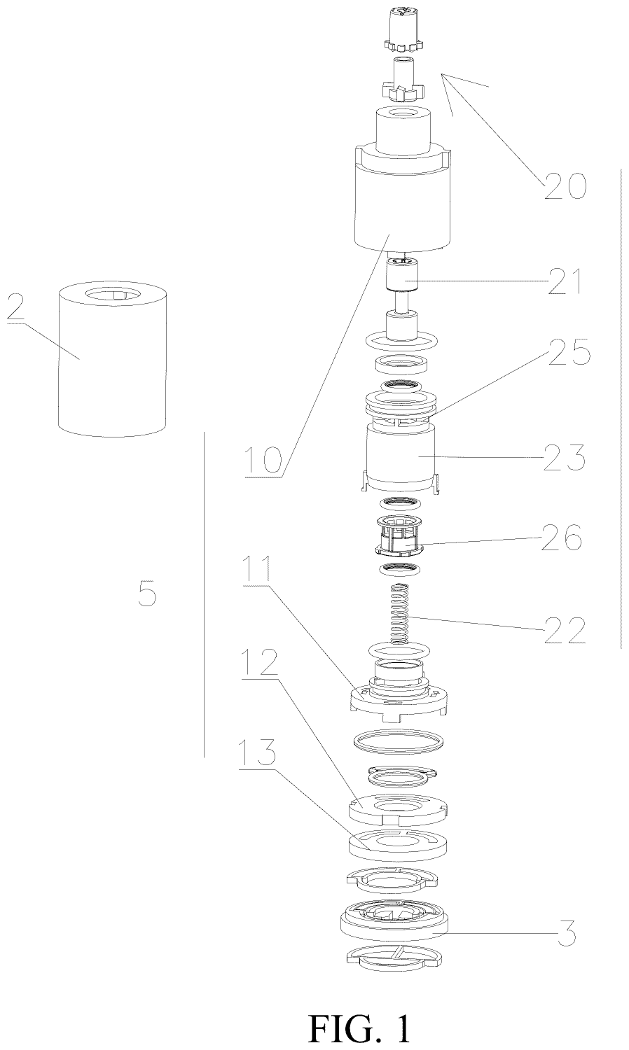

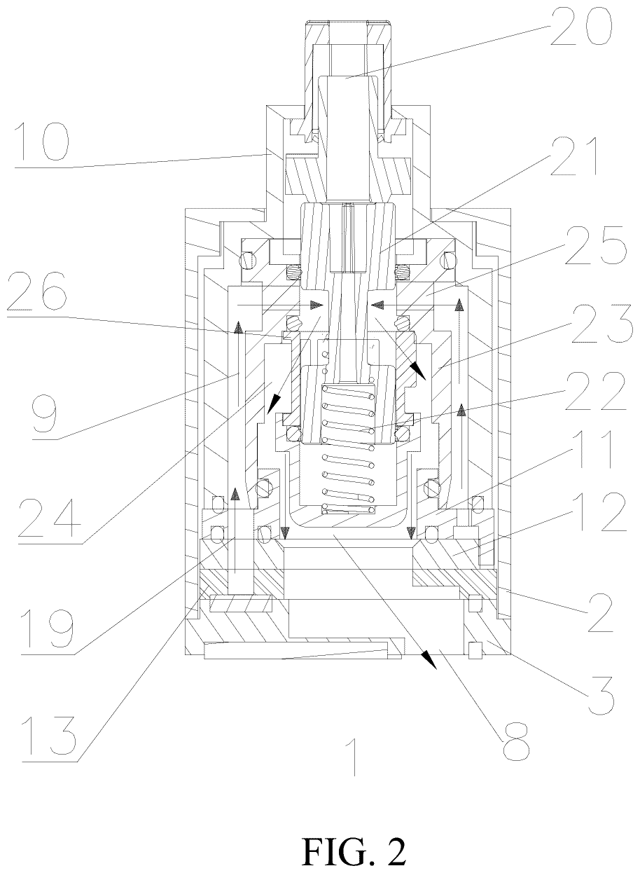

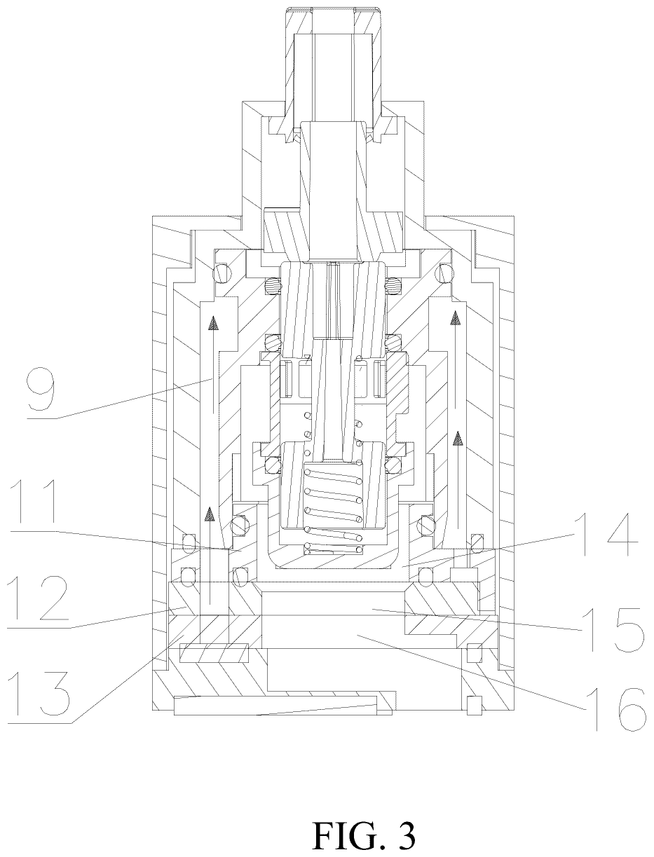

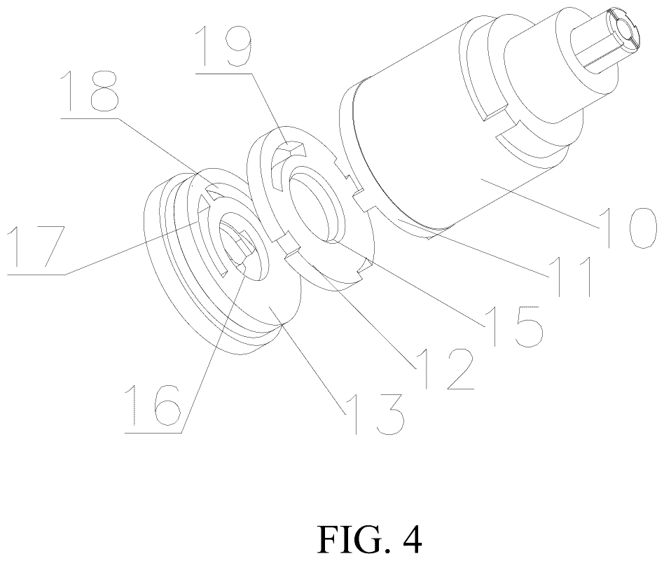

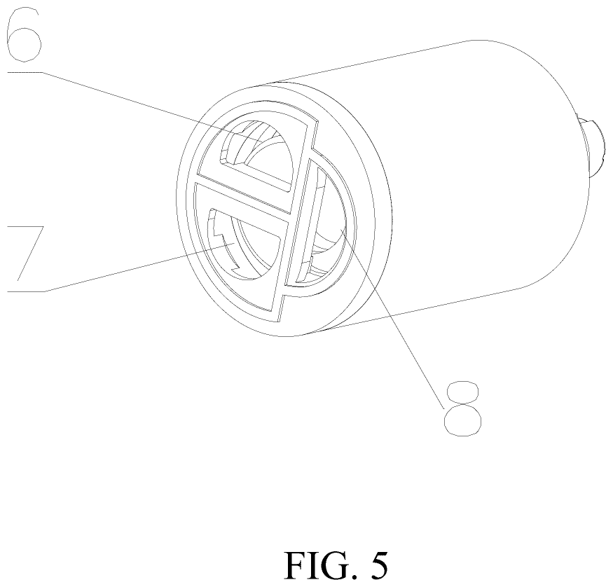

As shown in FIG. 1 to FIG. 5, the embodiment of the present disclosure provides a combined valve core with a changeable function, including valve core body 1. The valve core body 1 includes outer housing 2, base 3, first operating portion 4, and second operating portion 5. The base 3 is detachably provided at a bottom of the outer housing 2. The first operating portion 4 and the second operating portion 5 are provided in the housing. First water inlet 6 for receiving hot water, second water inlet 7 for receiving cold water, and water outlet 8 are arranged on the base 3. The hot water and the cold water come into the valve core body 1 respectively from the first water inlet 6 and the second water inlet 7, then pass through a channel in the first operating portion 4 and a channel in the second operating portion 5, and come out of the water outlet 8 at last, thereby forming complete water flow channel 9. After coming into the second operating portion 5, a flow rate of the hot water and a flow rate of the cold water converged into the water flow channel 9 are adjusted by the second operating portion 5 at the same time to adjust a temperature of a water flow leaving from the water outlet 8. The first operating portion 4 is configured to switch off or on the water flow channel 9 in a first switching manner, thereby controlling water from the water outlet 8. The second operating portion 5 is configured to adjust the temperature in a second switching manner. Two switching manners do not conflict and affect with each other. Hence, the combined valve core with a changeable function does not affect the water temperature during switching in operation, thereby improving the use experience.

Preferably, the second operating portion 5 includes upper rotating shaft housing 10, lower housing seat 11, movable ceramic plate 12, and fixed ceramic plate 13. The upper rotating shaft housing 10 is coaxially provided on the lower housing seat 11. The lower housing seat 11 is coaxially provided on the movable ceramic plate 12. The fixed ceramic plate 13 is fixedly provided on the base 3. The movable ceramic plate 12 and the fixed ceramic plate 13 can rotate relatively. An upper end of the rotating shaft housing 10 extends out of the outer housing 2. The rotating shaft housing and the outer housing can rotate relatively. The second switching manner is as follows: By rotating the upper rotating shaft housing 10 extending out of the outer housing 2, the lower housing seat 11 is driven to rotate. The lower housing seat 11 drives the movable ceramic plate 12 to rotate relative to the fixed ceramic plate 13, thereby adjusting the temperature.

Further, first water outlet channel 14 formed in the lower housing seat 11, second water outlet channel 15 formed in the movable ceramic plate 12, and third water outlet channel 16 formed in the fixed ceramic plate 13 are communicated with each other. The third water outlet channel 16 communicates with the water outlet 8. First water inlet channel 17 and second water inlet channel 18 are formed in the fixed ceramic plate 13. The first water inlet channel 17 and the second water inlet channel 18 respectively communicate with the first water inlet 6 and the second water inlet 7. Converging channels 19 are respectively formed in the lower housing seat 11 and the movable ceramic plate 12 in a penetrating and communicating manner. The first water inlet channel 17 and the second water inlet channel 18 have a same radius as the converging channel 19 in the movable ceramic plate 12. When the movable ceramic plate 12 rotates, the converging channel 19, the corresponding first water inlet channel and the corresponding second water inlet channel change in communicating aperture at the same time. By adjusting a proportion of the flow rate of the cold water to the flow rate of the hot water in convergence, the temperature of the converged water flow is adjusted.

Preferably, the upper rotating shaft housing 10 is internally hollow. The first operating portion 4 is provided in the upper rotating shaft housing 10. The first operating portion 4 includes pressing assembly 20, sealing shaft 21, reset spring 22, and upper water distribution housing 23. The sealing shaft 21 includes an upper end abutting against the pressing assembly 20, and a lower end abutting against the reset spring 22. A lower end of the reset spring 22 abuts against the lower housing seat 11. An upper end of the pressing assembly 20 extends out of the upper rotating shaft housing 10. The upper water distribution housing 23 is fixed on the lower housing seat 11. Inner cavity 24 is formed in the upper water distribution housing 23. A plurality of through grooves 25 for communicating the water flow channel 9 are formed around the upper water distribution housing 23. The sealing shaft 21 slidably abuts against an inner sidewall of each of the through grooves 25 to switch on or off the through groove 25. The pressing assembly 20 functionally serves as a switch portion of the present disclosure, to realize on-off by pressing. The pressing assembly 20 includes a stator and a rotor in action principle. In cooperation with the sealing shaft 21 and the reset spring 22 under the pressing assembly, the pressing assembly forms a push-button switch structure of a ball-point pen. The principle is the prior art, and is not repeated herein. In the present disclosure, as can be known, after the upper water distribution housing 23 and the upper rotating shaft housing 10 are provided on the lower housing seat 11 in a sealing manner, an inner cavity as a part of the water flow channel 9 is formed between the upper water distribution housing and the upper rotating shaft housing. Coming from the converging channel 19, the water comes into the upper water distribution housing 23 through the through groove 25, then passes through the first water outlet channel 14, the second water outlet channel 15, and the third water outlet channel 16 downward, and comes out of the valve core body 1 from the water outlet 8, thereby forming a complete process of the water flow in the valve core body 1. The water channel through which the water flow passes through in the process is the water flow channel 9. The sealing shaft 21 is provided in a shape big at two ends and small in the middle. Hence, the second switching manner is as follows: Through the push-button switch formed by the pressing assembly 20 and the reset spring 22, the sealing shaft 21 can move back and forth on a central axis of the upper water distribution housing 23. With the sealing ring, when one end of the sealing shaft 21 moves back and forth at the through groove 25, the through groove 25 is obstructed to switch off and on the water flow channel 9.

Preferably, the first operating portion 4 further includes water distributor 26. The water distributor 26 is located between the lower housing seat 11 and the upper water distribution housing 23. The water distributor 26 is hollow tubular. A plurality of openings for allowing the water flow to pass through are formed around the water distributor in a penetrating manner. When the sealing shaft 21 moves back and forth, the water distributor 26 can serve to limit and guide the sealing shaft to some extent. Meanwhile, when allowing the water flow to pass through, the water distributor 26 also can serve to mitigate the water flow to some extent.

The mounting manner in the present disclosure may be snap-fit, may be threaded connection, and may also be embedded location of a bump and a groove, thereby realizing coaxial rotation.

Therefore, by separating the switching and the temperature adjustment apart, the present disclosure does not affect the temperature during switching, and does not affect the temperature of the water flow for the touch by mistake. Meanwhile, the first operating portion 4 and the second operating portion 5 are coaxial, which can utilize the space greatly, reduces the size, and optimize the water channel.

### Embodiment 2

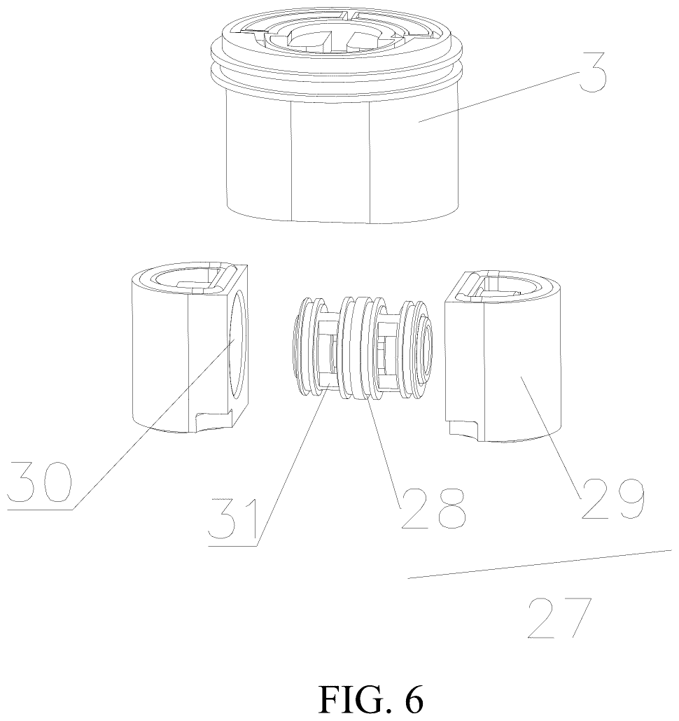

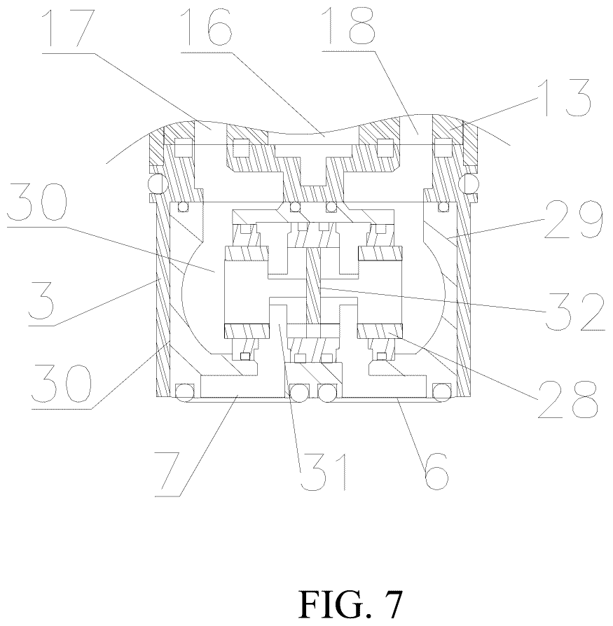

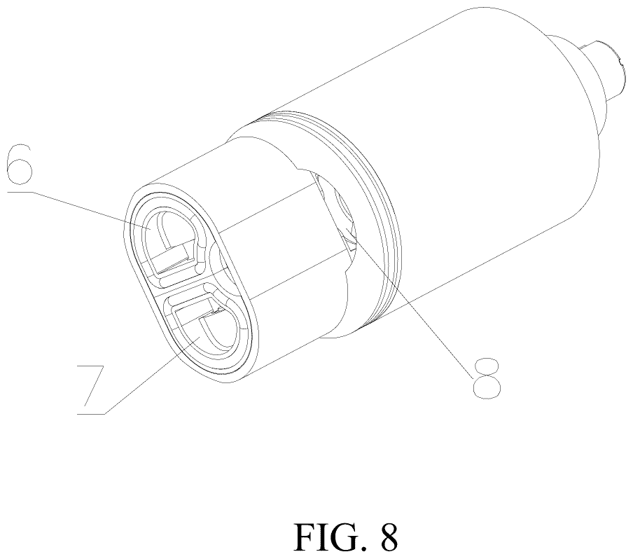

As shown in FIGS. 6-8, the embodiment differs from Embodiment 1 in: The combined valve core with a changeable function further includes pressure balancing module 27. Connecting cavity 33 communicating with the first water inlet 6 and the second water inlet 7 is further provided in the base 3. The pressure balancing module 27 is provided in the connecting cavity 33. Since the base 3 is detachably provided, the base 3 in different implementations may be selected in use according to different demands. The pressure balancing module 27 includes balancing core 28 and two mounting valve seats 29 symmetrically provided in the base 3. Balancing cavity 30 is provided in the mounting valve seat 29. Two balancing cavities 30 communicate with each other. The balancing core 28 is fixedly provided between the two balancing cavities 30, to separate the two balancing cavities 30 apart. One balancing cavity 30 includes an upper end communicating with the first water inlet channel 17, and a lower end communicating with the first water inlet 6, so as to connect the hot water. The other balancing cavity 30 includes an upper end communicating with the second water inlet channel 18, and a lower end communicating with the second water inlet 7, so as to connect the cold water. Two ends of the balancing core 28 are open. The middle of the balancing core 28 is provided with diaphragm 32, and the circumference of the balancing core 28 is symmetrically provided with two through hole portions 31. The through hole portions 31 are respectively provided at two sides of the diaphragm 32. With the pressure balancing module 27, the water flow from the first water inlet 6 and the second water inlet 7 comes into the balancing core 28 in the balancing cavity 30 through the through hole portions 31 first, and then comes into the respective water channel. In the embodiment, the two balancing cavities 30 are separated by the diaphragm 32. In case of a pressure imbalance between the flow rate of the cold water and the flow rate of the hot water at the two sides of the diaphragm, the side with the larger pressure of the water flow squeezes the diaphragm 32, such that the diaphragm protrudes toward the other side. Consequently, the space of the balancing cavity 30 at the other side is reduced, and when the water flow passes through the space, the flow velocity is improved. Conversely, the space at the original side is increased, and the flow velocity is slowed down. After the water flows are converged, the water temperature can be balanced, and the converged water flow is stable.

### Embodiment 3

The embodiment further provides a water outlet device, including the combined valve core with a changeable function.

In use, by pressing the input end of the first operating portion 4, the device can be switched on or off. By rotating the input end of the second operating portion 5, the temperature of the water of the water outlet device can be adjusted. The two switching manners do not affect to each other. The water outlet device prevents the water temperature from being affected during switching, thereby improving the use experience in water utilization.

The above described are merely preferred implementations of the present disclosure and is not intended to limit the present disclosure, and various changes and modifications of the present disclosure may be made by those skilled in the art. Any modifications, equivalent substitutions, improvements, etc. made within the spirit and principle of the present disclosure should be included in the protection scope of the present disclosure.

1. A combined valve core with a changeable function, comprising a valve core body, wherein the valve core body comprises an outer housing, a base, a first operating portion and a second operating portion; wherein
the base is detachably provided at a bottom of the outer housing; a first water inlet for receiving hot water, a second water inlet for receiving cold water, and a water outlet are arranged on the base; and a water flow channel communicating with the first water inlet, the second water inlet and the water outlet is formed in the valve core body; and
the first operating portion is configured to switch the water flow channel in a first switching manner; and the second operating portion is configured to adjust, in a second switching manner, a flow rate of the hot water and a flow rate of the cold water converged into the water flow channel to adjust a temperature of a water flow leaving from the water outlet.

2. The combined valve core with the changeable function according to claim 1, wherein the first operating portion and the second operating portion are coaxial.

3. The combined valve core with the changeable function according to claim 1, wherein the first switching manner is pressing; and the second switching manner is rotating.

4. The combined valve core with the changeable function according to claim 3, wherein an output end of the first operating portion is located in the outer housing and configured to switch the water flow channel, and an input end of the first operating portion extends out of the outer housing; and an output end of the second operating portion is located in the outer housing and configured to adjust the temperature of the water flow, and an input end of the second operating portion extends out of the outer housing.

5. The combined valve core with the changeable function according to claim 1, further comprising a pressure balancing module, wherein a connecting cavity communicating with the first water inlet and the second water inlet is further provided in the base; and the pressure balancing module is provided in the connecting cavity.

6. The combined valve core with the changeable function according to claim 5, wherein the pressure balancing module comprises a balancing core and two symmetrical mounting valve seats; two balancing cavities are respectively provided in the two symmetrical mounting valve seats; the two balancing cavities are correspondingly connected; the balancing core is provided between the two balancing cavities, to separate the two balancing cavities apart; a first balancing cavity of the two balancing cavities is configured for the hot water to pass through; and a second balancing cavity of the two balancing cavities is configured for the cold water to pass through.

7. The combined valve core with the changeable function according to claim 6, wherein two ends of the balancing core are open; a middle of the balancing core is provided with a diaphragm, and a circumference of the balancing core is symmetrically provided with two through hole portions; and the two through hole portions are respectively provided at two sides of the diaphragm.

8. A water outlet device, comprising the combined valve core with the changeable function according to claim 1.

9. The water outlet device according to claim 8, wherein in the combined valve core with the changeable function, the first operating portion and the second operating portion are coaxial.

10. The water outlet device according to claim 8, wherein in the combined valve core with the changeable function, the first switching manner is pressing; and the second switching manner is rotating.

11. The water outlet device according to claim 10, wherein in the combined valve core with the changeable function, an output end of the first operating portion is located in the outer housing and configured to switch the water flow channel, and an input end of the first operating portion extends out of the outer housing; and an output end of the second operating portion is located in the outer housing and configured to adjust the temperature of the water flow, and an input end of the second operating portion extends out of the outer housing.

12. The water outlet device according to claim 8, wherein in the combined valve core with the changeable function, the combined valve core with the changeable function further comprises a pressure balancing module, wherein a connecting cavity communicating with the first water inlet and the second water inlet is further provided in the base; and the pressure balancing module is provided in the connecting cavity.

13. The water outlet device according to claim 12, wherein in the combined valve core with the changeable function, the pressure balancing module comprises a balancing core and two symmetrical mounting valve seats; two balancing cavities are respectively provided in the two symmetrical mounting valve seats; the two balancing cavities are correspondingly connected; the balancing core is provided between the two balancing cavities, to separate the two balancing cavities apart; a first balancing cavity of the two balancing cavities is configured for the hot water to pass through; and a second balancing cavity of the two balancing cavities is configured for the cold water to pass through.

14. The water outlet device according to claim 13, wherein in the combined valve core with the changeable function, two ends of the balancing core are open; a middle of the balancing core is provided with a diaphragm, and a circumference of the balancing core is symmetrically provided with two through hole portions; and the two through hole portions are respectively provided at two sides of the diaphragm.
